(19) United States
(12) Patent Application Publication
(10) Pub. No.: US 2015/0196980 A1
(43) Pub. Date: Jul. 16, 2015

(54) METHOD OF MANUFACTURING GEAR WITH TEETH INVOLVING FORGING

(71) Applicant: Shivam Autotech Ltd., New Delhi (IN)

(72) Inventor: Neeraj Munjal, New Delhi (IN)

(21) Appl. No.: 14/155,713

(22) Filed: Jan. 15, 2014

(51) Int. Cl. B23P 15/14; B23F 17/00; F16H 55/06; B21K 1/30

(52) U.S. Cl. CPC B23P 15/14; B21K 1/30; B23F 17/00; F16H 55/06

(57) ABSTRACT

The present invention is relating to method of manufacturing a gear with teeth, a component to be applied in motor cycle; wherein the formation of said gear teeth is achieved mainly through forging process.

### FIELD OF THE PRESENT INVENTION

The present invention relates to the manufacturing a gear with teeth therein, which is an auto component mainly to be used in motor cycles; wherein the said gear teeth are mainly prepared in forging process.

### BACKGROUND AND OBJECT OF THE PRESENT INVENTION

Gears, mainly with teeth provisions, are important auto components, being used in the engine transmission of motor cycles. Conventionally such gears are manufactured using machining process involving hobbing & deburring processes.

Due to such conventional processes of the production of gear with teeth, the said auto component is associated with certain types of drawbacks, such as more consumption of resources and time; involvement of various machining steps towards formation of the central hole as well as formation of teeth profile; formation of substantial amount of wastage material etc.

Due to multiple machining operations, the grain or the internal structure of the work piece gets effected and therefore properties like very high stress bearing capacity, corrosion resistance, high temperature tolerance and very high structural strength etc. get adversely affected.

Due to involvement of large number of machining tools in the preparation of teeth in the gear, a number of instrumental errors, work-piece handling errors and incidental errors are possible, which mainly depend on the expertise of tool designing and proper handling of various operations thereafter. These unintentional errors, involved in the production of gear with teeth, become reasons for accidental breakdown of the said gear with teeth, much prior to the expected life of the gear component.

Application of single step forging process for the production of Gear with teeth is not conventionally being practiced, mainly due to following reasons:
(i) Technical complications in die designing for commercial production of the said component;
(ii) Non-achievement of ideal forging conditions for producing commercially acceptable gear with teeth;
(iii) Involvement of so many dimensional aspects of the said auto component of various size range, namely the central hole creation, size optimization of the said component, teeth formation etc., which are difficult to consider in one single standardized process, mainly towards achieving all required and preferred structural and functional features of the said auto component.

Therefore the present invention is mainly intended to propose a manufacturing method, which mainly involve forging towards production of the auto component gear with teeth, wherein the process further involves supporting secondary steps after accomplishing said forging towards gear teeth formation, such as annealing, shot blasting, phosphating and teeth cold extrusion. The said invention proposes a gear with teeth auto component, which is much advanced in its properties in comparison to the similar conventional auto components prepared through conventional processes, namely in terms of very high stress bearing capacity, corrosion resistance, high temperature tolerance and very high structural strength etc.

The main object of the present invention is to manufacture a gear with teeth by mainly involving horizontal hot forging process, mainly in the teeth formation therein and without performing hobbing and deburring processes; and therefore the said produced gear with teeth is expected to have much advanced properties like very high stress bearing capacity, corrosion resistance, high temperature tolerance and very high structural strength etc.

Another prime object of the present invention is to propose a new method of manufacturing gear with teeth, wherein the said method primarily involve horizontal hot forging towards creation of teeth in the said gear component, followed by secondary operations, namely annealing shot blasting, phosphating and teeth cold extrusion in step wise manner; and wherein the said method proposed herein does not involve the gear hobbing and deburring operations towards teeth formation in the said gear component.

Further other object of the present invention is to propose a new die, suitable for horizontal hot forging towards manufacturing of a gear with teeth of variable range of desired shape, size, dimension, surface pattern and configuration, as being produced herein.

Further other object of the present invention is to propose a method for manufacturing the gear with teeth, wherein the said method, after performing horizontal hot forging and its supporting operations, namely annealing, shot blasting, phosphating and teeth cold extrusion in stepwise manner, involves operations of CNC machining, broaching, saving, case carburizing, and shot blasting in stepwise manner, mainly towards obtaining the final finished product.

### DESCRIPTION OF THE PRESENT INVENTION

Gears are used extensively for transmission of power. They find application in automobiles, gear-boxes, oil engines, machine tools, industrial machinery, agricultural machinery, geared motors etc. To meet the strenuous service conditions the gears should have robust construction, reliable performance, high efficiency, economical and long life. Gears should be fatigue free and free from high stresses to avoid their frequent failures. The gear drives should be free from noise, chatter and should ensure high load carrying capacity at constant velocity ratio. To meet all the above conditions, the gear manufacturing has become a highly specialized field.

The present invention describes a new method for manufacturing a gear with teeth, which achieve the teeth formation by horizontal hot forging using a suitably designed new closed die and it does not involve the conventional hobbing-cum-deburring operations for the same. After forging, the work piece is subjected to other supporting operations like annealing shot blasting, phosphating and teeth cold extrusion are performed in stepwise manner.

Hot or warm forging has a number of cost-saving advantages which underscore its increasing use as a manufacturing method. The temperature range for the warm forging of steel runs from above room temperature to below the recrystallization temperature, or from about 800 to 1,800 degrees Fahrenheit. However, the narrower range of from 1,000 to 1,330 degrees Fahrenheit is the best suited range for warm forging. Compared with cold forging, warm forging has the potential advantages of reduced tooling loads, reduced forging press loads, increased steel ductility, elimination of need to anneal prior to forging, and favorable as-forged properties that can eliminate heat treatment.

The raw material, that is the piece of steel billet, after inspection undergoes horizontal hot forging wherein, using a suitable closed die of preferred size and dimension of the gear with teeth profile, the main body of the gear with teeth is forged and prepared. Due to such gear with teeth making process, the whole set of conventional processes involved in gear making and teeth creating activities get eliminated or completely changed. The present invention completely eliminates the involvement of conventional operations of hobbing, followed by deburring, mainly due to performing hot forging operation towards creating all necessary structural features of said gear with its teeth pattern in forging only. The following schematic chart represents the set of steps involved in the present proposed manufacturing method:

RAW MATERIAL (STEEL) INSPECTION

FORGING (on horizontal hot forging)
ANNEALING
SHOT BLASTING
PHOSPATING
TEETH COLD EXTRUSION
CNC-1
CNC-2
BROACHING
SHAVING
CASE CARBURIZING
SHOT BLASTING
GEAR ROLLING 100%

The degree of structural reliability achieved in a forging is unexcelled by any other metalworking process. There are no internal gas pockets or voids that could cause unexpected failure under stress or impact. Forging yields a grain structure oriented to the part shape, resulting in optimum strength, ductility and resistance to impact and fatigue; wherein a machined device or component may be more susceptible to fatigue and stress corrosion because machining cuts material grain pattern. In this proposed method, all the major structural features like central hole as well as complete teeth profile gets created during horizontal hot/warm forging. With proper designing and dimension-selection pertaining to central hole diameter and tooth length/shape/orientation etc.; a suitable closed die is prepared and applied for performing the proposed horizontal hot forging towards preparing the present gear with teeth.

Immediately after performing the said forging, to enhance structural strength and other properties of the gear component and to optimize the grain profile of the said gear with teeth component, the work piece is subjected to a set of operations, which are annealing, shot blasting, phosphating and teeth cold extrusion.

During annealing, the forged work piece is subjected to heat treatment wherein the material of the said work piece is altered, causing changes in its properties such as strength and hardness. It is a process that produces conditions by heating to above the recrystallization temperature, maintaining a suitable temperature, and then cooling. Annealing is used to induce ductility, soften material, relieve internal stresses, refine the structure by making it homogeneous, and improve cold working properties.

In shot blasting or abrasive blasting stage, the work piece undergoes smoothening of its rough surface, shaping of the surface and removal of surface contaminants therein. A pressurized fluid, typically air, or a centrifugal wheel is used to propel the media in the operation.

Phosphate coating (phosphating) is a conversion coating consisting of an insoluble crystalline metal-phosphate salt formed in a chemical reaction between the substrate metal and a phosphoric acid solution containing ions of metals (zinc, iron or magnesium).

In next step, the work piece of the said gear with teeth is subjected to teeth cold extrusion, wherein the whole teeth profile of the said work piece is cold extruded at room temperature or near room temperature. Such processing further enhances the strength and stress tolerance of the subject and provides excellent surface finish to gear teeth therein.

Apart from above forging process as well as other supportive processes, certain additional gear making processes are performed towards finalizing the gear with teeth component, which are mainly CNC machining, broaching, shaving, case carburizing and shot blasting. These additional steps performed towards making of present gear with teeth further enhance the structural features, performance and life of the said gear with teeth component.

Broaching and saving refines and smoothen further the edges and corners of various elevations and depressions created on the gear with teeth component, especially the teeth profile therein. Case hardening or surface hardening is the process of hardening the surface of metal, often low carbon steel, by infusing elements into the material's surface, forming a thin layer of a harder alloy. Case hardening is usually done after the part in question has been formed into its final shape. Carburizing basically is a heat treatment process in which iron or steel is heated in the presence of another material (in the range of 900 to 950° C. (1,650 to 1,740° F.)) which liberates carbon as it decomposes. Depending on the amount of time and temperature, the affected area can vary in carbon content. Longer carburizing times and higher temperatures lead to greater carbon diffusion into the part as well as increased depth of carbon diffusion. Finally shot blasting creates a smooth and finished surface to the gear with teeth component.

The description of the invention is further supported with certain drawings, wherein short titles of these drawings are as under:

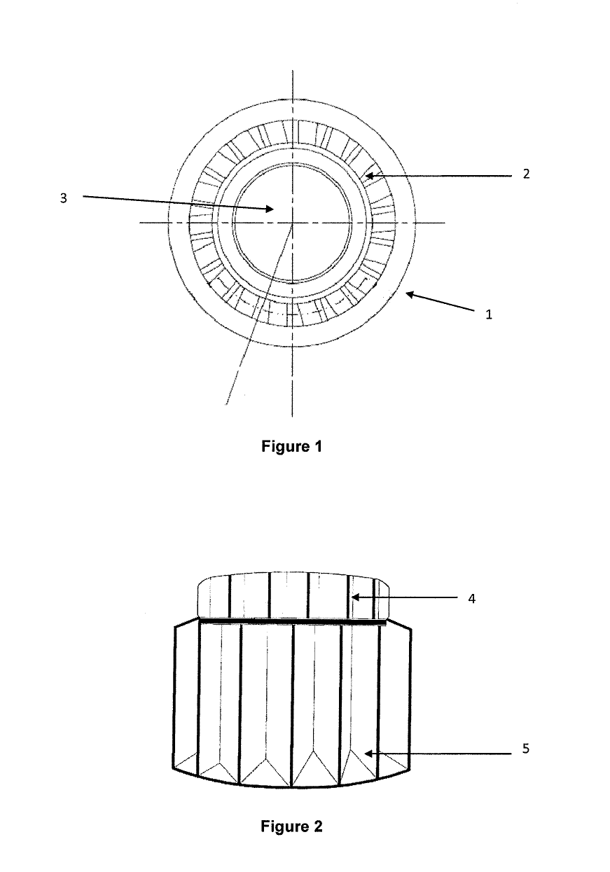

FIG. 1: it represents one schematic views of the forged work piece of the gear with teeth, as proposed herein;

FIG. 2: it represents one schematic views of the finished gear with teeth component, as proposed herein;

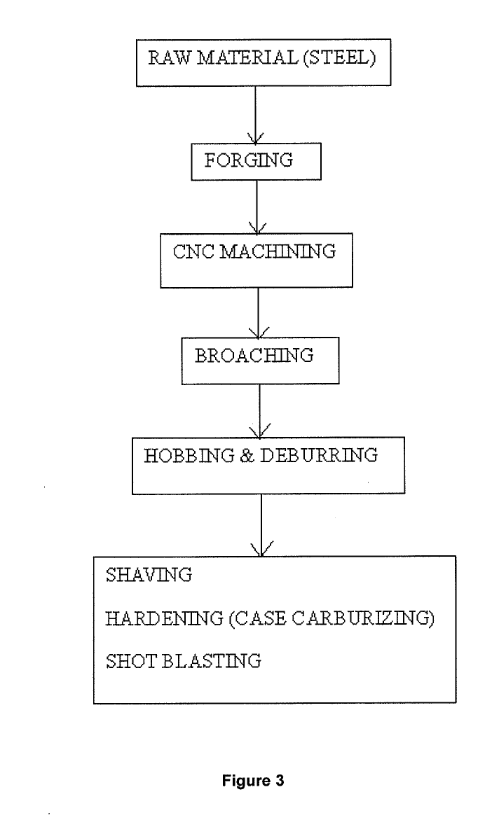

FIG. 3: It is a schematic chard diagram, representing the major conventional steps involved in the manufacturing of conventional gear with teeth profile;

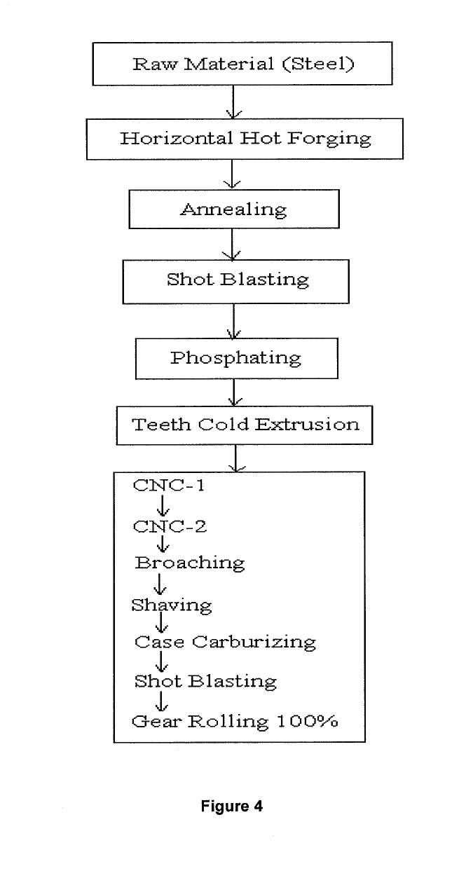

FIG. 4: It is a schematic chart diagram, representing the major steps like horizontal hot forging, annealing, shot blasting, phosphating and teeth cold extrusion, involved in the present proposed method of manufacturing of the present gear with teeth, wherein the proposed method specifically does not include performing the hobbing and deburring operations towards creation of central hole and teeth pattern formation in the said gear therein.

As shown in FIG. 1, the forged work-piece 1 comprises of all essential structural features, such as the teeth profile 2 and the central hole 3, along with the complete surface and gear pattern as indicated in FIG. 2 through numerals 4 and 5. The work-piece 1 requires surface strengthening and refining of the body part and at the same time refinement in the teeth profile of the said gear. Such after-forging operations are performed one by one in continuous manner, as indicated in FIG. 4. After forging the work-piece 1 undergoes annealing and then it is subjected to certain operations, mainly shot blasting, phosphating, teeth cold extrusion, CNC machining, broaching, saving, case carburizing and shot blasting etc. FIG. 4 indicates that the proposed method herein completely exclude hobbing and deburring operations, unlike the conventional such methods, indicated in FIG. 3.

### SCOPE OF THE INVENTION

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

We claim:

1. A method of manufacturing gear with teeth by involving horizontal hot forging process using a closed die, wherein creation of central hole and teeth formation therein is carried out during said forging operation and wherein the said method is devoid of performing hobbing and deburring processes therein.

2. A method of manufacturing gear with teeth involving forging, as claimed in claim 1, wherein the said method is characterized by performing the horizontal hot forging process using a suitable closed die and not performing of hobbing operation in teeth making step.

3. A method of manufacturing gear with teeth involving forging, as claimed in claim 1, wherein the said method of manufacturing gear with teeth is primarily characterized by carrying out of certain stepwise operations after performing the said forging operation, namely annealing, shot blasting, phosphating and teeth cold extrusion.

4. A method of manufacturing gear with teeth involving forging, as claimed in claim 1, wherein the said method is characterized by structural and functional properties of the said manufactured gear with teeth component, mainly in terms of its high stress bearing capacity, corrosion resistance, high temperature tolerance and high structural strength.

5. A method of manufacturing gear with teeth involving forging, as claimed in claim 1, wherein said forging operation applies a suitable closed die for creating structural features like central hole, teeth profile and other major surface elevations/depressions of the said gear component.

6. A gear with teeth, as claimed in claim 1, wherein the said gear, optionally of different shape, size, dimension, teeth profile, surface pattern and configuration is manufactured by the said method involving the horizontal hot forging process using a suitable closed die of corresponding shape, size, dimension, teeth profile, surface pattern and configuration therein and wherein the said method is devoid of performing hobbing and deburring processes therein.

7. A method of manufacturing gear with teeth involving forging, as claimed in claim 1, the closed die is suitable for horizontal hot forging towards manufacturing of a gear with teeth of variable optional range of desired shape, size, dimension, surface pattern and configuration.

8. A method of manufacturing gear with teeth involving forging, as claimed in claim 1, wherein the said method, after performing said forging and supporting operations in continuous stepwise manner, namely annealing, shot blasting, phosphating and teeth cold extrusion, is characterized by carrying out of further additional operations in stepwise manner, of CNC machining, broaching, shaving, case carburizing and shot blasting in step wise manner therein.

9. A method of manufacturing gear with teeth involving forging, substantially as herein described and illustrated in the figures of the accompanying drawings.
